(19) United States
(12) Patent Application Publication
(10) Pub. No.: US 2021/0348436 A1
(43) Pub. Date: Nov. 11, 2021

(54) OPENING-CLOSING CONTROL SYSTEM, OPENING-CLOSING CONTROL METHOD, AND STORAGE MEDIUM

(71) Applicant: Panasonic Intellectual Property Management Co., Ltd., Osaka (JP)

(72) Inventors: Makoto HIROKI, Osaka (JP); Fumiyosi MUKOYAMA, Osaka (JP); Yoko FUJIWARA, Osaka (JP)

(21) Appl. No.: 17/286,475

(22) PCT Filed: Oct. 23, 2019
(86) PCT No.: PCT/JP2019/041427

§ 371 Date: Apr. 18, 2021

(30) Foreign Application Priority Data
Oct. 24, 2018 (JP) 2018-199931

(51) Int. Cl. E05F 15/72; E05F 15/77

(52) U.S. Cl. CPC E05F 15/72; E05F 15/77; E05Y 2900/146; E05Y 2400/52; E05Y 2900/132; E05Y 2400/66

(57) ABSTRACT

The opening-closing control system includes an outputter that outputs a control signal for controlling an operation of an opening-closing member configured to open and close an opening provided in a first facility, and an obtainer that obtains alert information on an alert from a second facility different from the first facility. Then, the outputter outputs the control signal for controlling the opening or closing of the opening by the opening-closing member based on the information.

### TECHNICAL FIELD

The present disclosure relates to an opening-closing control system, an opening-closing control method, and a program.

### BACKGROUND ART

In a fire, it is known that the transfer of fire from a facility where a fire is occurring to another facility passes through openings such as windows and doors provided in the facility.

Therefore, Patent Literature (PTL) 1 discloses a shutter device including an automatic closing device that releases the brake of the switch and lowers the shutter curtain by its own weight in the event of a fire.

### CITATION LIST

### Patent Literature

[PTL 1] Japanese Unexamined Patent Application Publication No. 2008-31714

### SUMMARY OF INVENTION

### Technical Problem

In a facility where a conventional shutter device is located, the shutter device receives a fire signal of a fire that has occurred in the facility, and the shutter device lowers the shutter curtain by its own weight. However, this shutter device has not been able to lower the shutter curtain based on the fire signal of a fire that has occurred at another facility.

It is an object of the present disclosure to provide an opening-closing control system, an opening-closing control method, and a program capable of suppressing the transfer of fire to the own facility when a fire occurs in a facility different from the own facility.

### Solution to Problem

In order to achieve the above object, the opening-closing control system according to one aspect of the present disclosure includes: an outputter that outputs a signal for controlling an operation of an opening-closing member configured to open and close an opening provided in a first facility; and an obtainer that obtains information on an alert from a second facility different from the first facility, wherein the outputter outputs the signal for controlling the opening or closing of the opening by the opening-closing member based on the information.

In addition, the opening-closing control method according to one aspect of the present disclosure includes: outputting a signal for controlling an operation of an opening-closing member configured to open and close an opening provided in a first facility; obtaining information on an alert from a second facility different from the first facility; and outputting the signal for controlling the opening or closing of the opening by the opening-closing member based on the information obtained.

In addition, the program according to one aspect of the present disclosure causes a computer to execute the opening-closing control method.

### Advantageous Effects of Invention

According to the opening-closing control system, opening-closing control method, and program according to the present disclosure, when a fire occurs in a facility different from the own facility, it is possible to suppress the transfer of fire to the own facility.

### BRIEF DESCRIPTION OF DRAWINGS

FIG. 1 is a block diagram showing an opening-closing control system according to an embodiment.

FIG. 2A is a diagram showing a state in which the second facility issues an alert information and a state in which the first facility receives the alert information.

FIG. 2B is a diagram showing a state in which the opening-closing member control device of the first facility closes the openings by the opening-closing members and a state in which the electric lock is unlocked, based on the received alert information.

FIG. 3 is a flowchart showing the operation of the opening-closing control system according to the embodiment.

FIG. 4 is a flowchart showing the operation of the opening-closing member control device according to the embodiment.

FIG. 5 is a block diagram showing an opening-closing control system further including a terminal device according to a variation.

FIG. 6 is a block diagram showing an opening-closing control system further including a terminal device and an information processing device according to a variation.

### DESCRIPTION OF EMBODIMENTS

Hereinafter, embodiments of the present disclosure will be described in detail with reference to the drawings. It should be noted that all of the embodiments described below show a specific example of the present disclosure. Therefore, the numerical values, shapes, materials, components, arrangement and connection forms of components, steps, order of steps, and the like shown in the following embodiments are examples, and are not intended to limit the present disclosure. Therefore, among the components in the following embodiments, the components not described in the independent claims are described as arbitrary components.

In addition, each figure is a schematic view and is not necessarily exactly illustrated. Therefore, for example, the scales and the like do not always match in each figure. In addition, in each figure, substantially the same configuration is designated by the same reference numerals, and duplicate description will be omitted or simplified.

First, the opening-closing control system, opening-closing control method, and program according to the present embodiment will be described.

### Embodiment

### Configuration

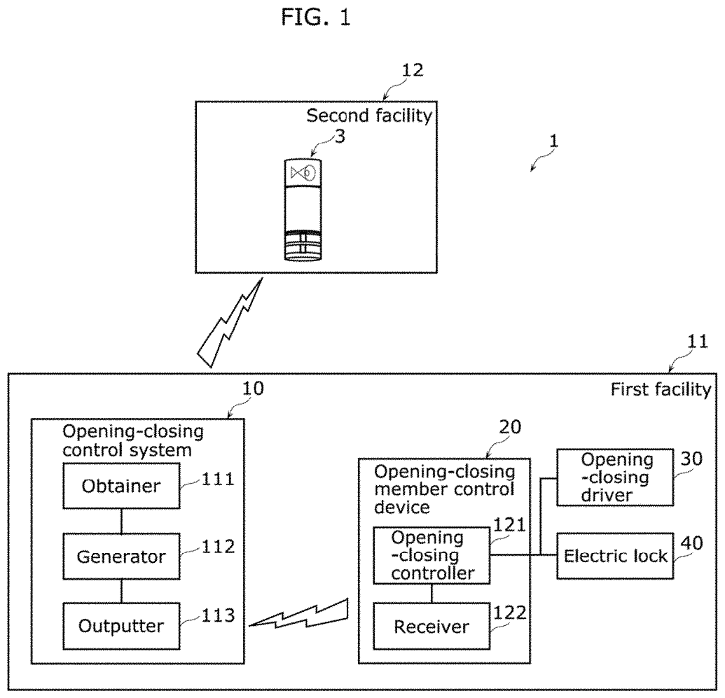

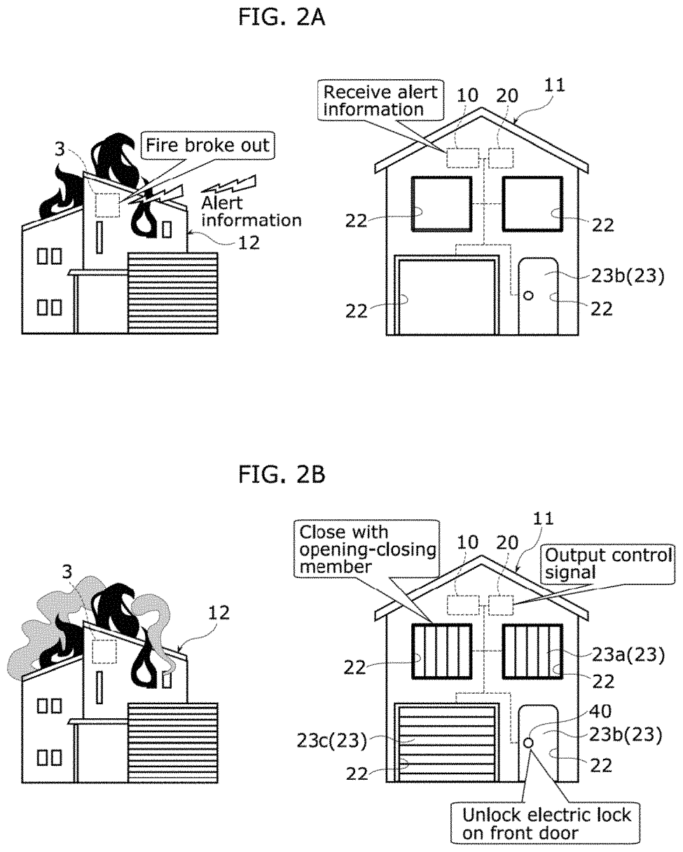

FIG. 1 is a block diagram showing opening-closing control system 10 according to an embodiment. FIG. 2A is a diagram showing a state in which second facility 12 issues an alert information and a state in which first facility 11 receives the alert information. FIG. 2B is a diagram showing a state in which opening-closing member control device 20 of first facility 11 closes openings 22 by opening-closing members 23 and a state in which electric lock 40 is unlocked, based on the received alert information.

As shown in FIG. 1, notification system 1 includes opening-closing control system 10, alert system 3, opening-closing member control device 20, opening-closing driver 30, and electric lock 40.

As shown in FIG. 1, FIG. 2A, and FIG. 2B, opening-closing control system 10 is a system in which when a fire has occurred in a certain facility among a plurality of facilities, openings 22 provided in each facility are opened and closed by opening-closing members 23 on receiving information on an alert (hereinafter, referred to as alert information) indicating that a fire has occurred in the certain facility. Opening-closing control system 10 may be, for example, a gateway, a smartphone, a dedicated terminal, or the like. In the present embodiment, it is assumed that opening-closing control system 10 is installed in each facility.

Here, the facility is a building such as an office building, a warehouse, or a house. Openings 22 are a window frame, an entrance doorway, a garage doorway, and the like that communicate the inside of the facility with the outside of the facility. A plurality of openings 22 are formed in each facility. As shown in FIG. 2B, opening-closing members 23 are window shutter 23a, entrance door 23b, garage shutter 23c, and the like. For example, window shutter 23a and garage shutter 23c include a shutter curtain that opens and closes each opening 22, and a guide rail that guides the shutter curtain. Entrance door 23b is an example of a door. Window shutter 23a and garage shutter 23c are examples of shutters.

As shown in FIG. 1, opening-closing control system 10 includes obtainer 11 generator 112, and outputter 113.

Obtainer 111 is a receiving device such as a communication module that obtains alert information issued by alert system 3 located in a facility (hereinafter referred to as second facility 12) different from the facility (hereinafter referred to as first facility 11). It should be noted that obtainer 111 may be a sensor or the like that detects the sound emitted by alert system 3.

Alert system 3 is an output device that outputs alert information that is a signal such as a radio wave signal, an electric signal, or the like. In the present embodiment, alert system 3 transmits alert information to one or more first facilities 11 in the vicinity of second facility 12 including alert system 3. Here, one or more first facilities 11 in the vicinity of second facility 12 are, for example, in the range of several meters, several tens of meters, several hundred meters, or the like from second facility 12. Alert system 3 performs wireless communication or wired communication by opening-closing control system 10 located between the respective facilities. In addition, alert system 3 may emit a sound as well as a radio wave signal or an electric signal. Alert system 3 is, for example, one or more fire alerts, smoke sensors, temperature sensors, and the like. In this way, the alert information is emitted as radio waves, sounds, and the like from alert system 3 provided in second facility 12.

As shown in FIG. 2A, the alert information is information on an alert output by alert system 3 when a fire occurs in second facility 12, for example, information indicating that a fire has occurred. The alert information may include information on the occurrence of a fire and information identifying the facility where the fire is occurring. It should be noted that FIG. 2A illustrates a state in which opening-closing control system 10 and opening-closing member control device 20 are mounted on first facility 11, but at least one of them may be located outside first facility 11.

Generator 112 generates signals (hereinafter referred to as control signals) for controlling the opening and closing of openings 22 by opening-closing member 23 based on the obtained alert information. Generator 112 outputs the generated control signals to opening-closing member control device 20 via outputter 113.

Outputter 113 outputs the control signals for controlling the opening and closing of openings 22 by opening-closing members 23 to opening-closing member control device 20 based on the alert information. The control signals are control commands for controlling the opening and closing of openings 22 by opening-closing members 23. The control signals include a closing control signal for controlling the operation of closing the shutter, which is opening-closing member 23, and an opening control signal for unlocking electric lock 40 of entrance door 23b, which is opening-closing member 23. That is, the closing control signal is a signal for closing the shutter based on the alert information, and the opening control signal is a signal for unlocking electric lock 40 of entrance door 23b based on the alert information. The opening control signal is an example of a signal for unlocking. The closing control signal is an example of a signal for closing the shutter.

Opening-closing member control device 20 is a device that controls the operations of opening-closing members 23 configured to open and close one or more openings 22 in each facility. Opening-closing member control device 20 includes opening-closing controller 121 and receiver 122.

Opening-closing controller 121 opens and closes openings 22 of first facility 11 by opening-closing members 23 by controlling opening-closing driver 30 based on the control signals. Specifically, when opening-closing controller 121 obtains the closing control signal, opening-closing controller 121 controls opening-closing driver 30 and closes openings 22 by window shutter 23a, shutter 23c, and the like. In addition, when opening-closing controller 121 obtains the opening control signal, opening-closing controller 121 unlocks the key of electric lock 40 locked on entrance door 23b.

Receiver 122 is a communication interface that obtains the control signals output by opening-closing control system 10. Receiver 122 outputs the obtained control signals to opening-closing controller 121.

Opening-closing driver 30 includes a drive mechanism, such as a motor, for opening and closing opening 22 by opening-closing member 23. Opening-closing driver 30 performs closing control for closing openings 22 by opening-closing members 23, and opening control for opening openings 22 by opening-closing members 23.

Electric lock 40 is a device that can electrically lock or unlock opening-closing member 23, that is, entrance door 23b, which is located in opening 22. It should be noted that in the present embodiment, opening-closing control system 10 may have only to output alert information for controlling the opening and closing of opening-closing member 23, and unlocking by electric lock 40 is not an indispensable constituent requirement.

### Operations

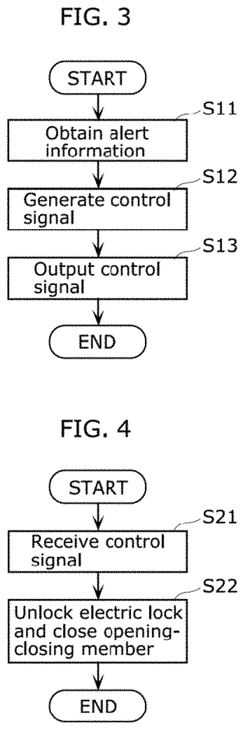

Here, assuming a case where a fire occurs in second facility 12, the operations of opening-closing control system 10 installed in first facility 11 in this case will be described with reference to FIG. 2A and FIG. 3.

FIG. 3 is a flowchart showing the operation of opening-closing control system 10 according to the embodiment.

As shown in FIG. 2A and FIG. 3, first, when alert system 3 of second facility 12 outputs alert information, opening-closing control system 10 of first facility 11 obtains the alert information (step S11). When obtainer 111 of opening-closing control system 10 obtains the alert information, obtainer 111 outputs the alert information to generator 112.

Next, generator 112 generates control signals for controlling the operations of opening-closing members 23 configured to open and close openings 22 of first facility 11 (step S12). Specifically, generator 112 generates an opening control signal for unlocking electric lock 40 of entrance door 23b of first facility 11 and a closing control signal for closing openings 22 of first facility 11 by opening-closing members 23, based on the obtained alert information.

Next, generator 112 outputs the generated control signals (opening control signal and closing control signal) to opening-closing member control device 20 via outputter 113 (step S13). Then, opening-closing control system 10 ends the process.

It should be noted that in step S12, an opening control signal and a closing control signal are generated as control signals, but it is only necessary that the closing control signal is generated, and the opening control signal is not essential. For this reason, the opening control signal may not be generated, and the opening control signal may not be output to opening-closing member control device 20.

Here, the operation of opening-closing member control device 20 based on the control signals received from opening-closing control system 10 will be described with reference to FIG. 23 and FIG. 3.

FIG. 3 is a flowchart showing the operation of opening-closing member control device 20 according to the embodiment.

As shown in FIG. 2B and FIG. 3, opening-closing member control device 20 receives the control signals (opening control signal and closing control signal) output by opening-closing control system 10 (step S21). Specifically, receiver 122 of opening-closing member control device 20 receives the opening control signal and the closing control signal, and outputs the received opening control signal and the received closing control signal to opening-closing controller 121.

Next, opening-closing controller 121 unlocks electric lock 40 of opening-closing members 23 based on the opening control signal, and controls opening-closing driver 30 based on the close control signal to close opening-closing members 23 (step S22). In FIG. 2B, opening-closing controller 121 unlocks electric lock 40 of entrance door 23b based on the opening control signal, and closes window shutter 23a and garage shutter 23c based on the closing control signal. Then, opening-closing member control device 20 ends the process.

In this way, when first facility 11 obtains the alert information from second facility 12, by closing opening 22 of first facility 11 by window shutter 23a and garage shutter 23c, it becomes difficult for the flame caused by the fire occurring outside to transfer (also referred to as catching fire) through opening 22. For this reason, in opening-closing control system 10, when a fire occurs in a facility near the own facility (second facility 12), it is possible to suppress the transfer of fire to the own facility. In addition, the person who is present in first facility 11 can escape from first facility 11 because electric lock 40 of entrance door 23b is in the unlocked state.

### Working Effects

Next, the working effects of opening-closing control system 10, the opening-closing control method, and the program in the present embodiment will be described.

As described above, opening-closing control system 10 according to the present embodiment includes outputter 113 that outputs control signals for controlling the operations of opening-closing members 23 configured to open and close openings 22 provided in first facility 11, and obtainer 111 that obtains alert information on an alert from second facility 12 different from first facility 11. Then, outputter 113 outputs the control signals for controlling the opening and closing of openings 22 by opening-closing members 23 based on the alert information.

According to this, for example, even if a fire occurs in second facility 12, opening-closing control system 10 of first facility 11 can output a control signal for closing openings 22 of first facility 11 by obtaining alert information. In this way, in opening-closing control system 10, even if a fire occurs in second facility 12 different from first facility 11, the opening-closing of openings 22 by opening-closing members 23 of first facility 11 can be controlled. For this reason, the fire occurring in second facility 12 is suppressed from transferring through openings 22 of first facility 11.

Therefore, opening-closing control system 10 can suppress the transfer of fire to first facility 11 when a fire occurs in second facility 12 different from first facility 11.

In addition, the opening-closing control method according to the present embodiment outputs control signals for controlling operations of opening-closing members 23 configured to open and close openings 22 provided in first facility 11, obtains information on an alert from second facility 12 different from first facility 11, and outputs the control signals for controlling the opening and closing of openings 22 by opening-closing members 23 based on the obtained alert information.

In addition, the program according to the present embodiment causes a computer to execute the opening-closing control method.

In these cases as well, the same working effects as described above are exhibited.

In addition, in opening-closing control system 10 according to the present embodiment, the alert information is emitted as a signal from alert system 3 provided in second facility 12 different from first facility 11.

According to this, opening-closing control system 10 can directly obtain the alert information issued by alert system 3 such as a fire alert. For this reason, opening-closing control system 10 can control the opening-closing of openings 22 by opening-closing members 23 of first facility 11 based on the alert information issued by alert system 3.

In addition, in opening-closing control system 10 according to the present embodiment, the alert information is emitted as a sound from alert system 3 provided in second facility 12 different from first facility 11.

According to this, for example, even in an environment where the radio wave does not reach opening-closing control system 10 from second facility 12, the alert information includes the sound from alert system 3 provided in second facility 12, so that opening-closing control system 10 can obtain the alert information more reliably.

In addition, in opening-closing control system 10 according to the present embodiment, opening-closing members 23 include shutters (window shutter 23a and garage shutter 23c). Then, outputter 113 outputs a closing control signal for closing the shutters based on the alert information.

According to this, when opening-closing control system 10 obtains alert information due to a fire that occurs outside first facility 11, openings 22 of first facility 11 can be closed by the shutters. For this reason, according to opening-closing control system 10, it becomes difficult in first facility 11 to transfer fire through openings 22.

In addition, in opening-closing control system 10 according to the present embodiment, opening-closing members 23 include a door. Then, outputter 113 outputs a signal for unlocking electric lock 40 of the door based on the alert information.

According to this, when a fire occurs in second facility 12, electric lock 40 of entrance door 23b is in an unlocked state, so that the person who is present in first facility 11 can escape from first facility 11.

### Other Variations, Etc.

Although the present disclosure has been described above based on the embodiment, the present disclosure is not limited to the above opening-closing control system, opening-closing control method, and program.

For example, in the opening-closing control system according to the above embodiment, the alert information from the alert system is alert information from the alert system associated with the opening-closing control system among the alert systems provided in the second facility different from the first facility. According to this, by associating the alert information from the alert system by the opening-closing control system in advance, the opening-closing control system can recognize the alert information transmitted by the alert system provided in the second facility. For example, it is possible to arbitrarily set which second facility is associated with the opening-closing control system among the alert systems of the plurality of second facilities existing around the first facility. For this reason, the opening-closing control system can appropriately control the opening-closing of the opening of the first facility by optimizing the second facility for which the alert information is obtained.

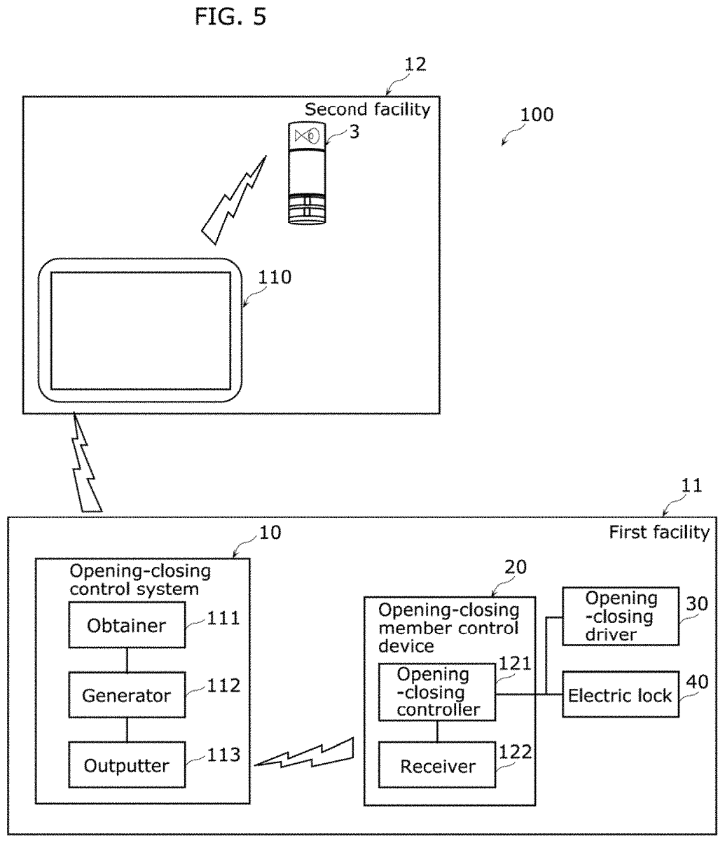

In addition, notification system 100 including opening-closing control system 10 according to the above embodiment may further include terminal device 110 as shown in FIG. 5. FIG. 5 is a block diagram showing opening-closing control system 10 further including terminal device 110 according to a variation. Terminal device 110 may be mounted on second facility 12, receive the alert information issued by alert system 3, and transmit the received alert information to opening-closing control system 10 of first facility 11 in the vicinity of second facility 12. That is, when the alert information of alert system 3 does not reach first facility 11 which is a facility outside second facility 12, opening-closing control system 10 may transmit the alert information to opening-closing control system 10 of first facility 11 via terminal device 110. In this case as well, opening-closing control system 10 may receive this alert information and output a control signal for closing opening 22 and an opening control signal for unlocking the key of electric lock 40 to opening-closing member control device 20. For this reason, even if the alert information of alert system 3 does not reach first facility 11 which is an external facility of second facility 12, alert system 3 can transmit the alert information to opening-closing control system 10 of first facility 11 via terminal device 110. For this reason, window shutter 23a of first facility 11 and garage shutter 23c can be reliably closed, and electric lock 40 of entrance door 23b can be reliably unlocked. Here, terminal device 110 may be, for example, a smartphone or the like, a dedicated device, or opening-closing control system 10.

It should be noted that terminal device 110 may not transmit the alert information to opening-closing control system 10 of first facility 11. Terminal device 110 may simply receive the alert information from alert system 3 and issue an alert in order to notify the user in second facility 12 based on the alert information. In this case, alert system 3 may transmit the alert information to opening-closing control system 10 of first facility 11.

In addition, the opening-closing control system according to the above embodiment may be integrated with the opening-closing member control device, or may be mounted on a server or a mobile terminal.

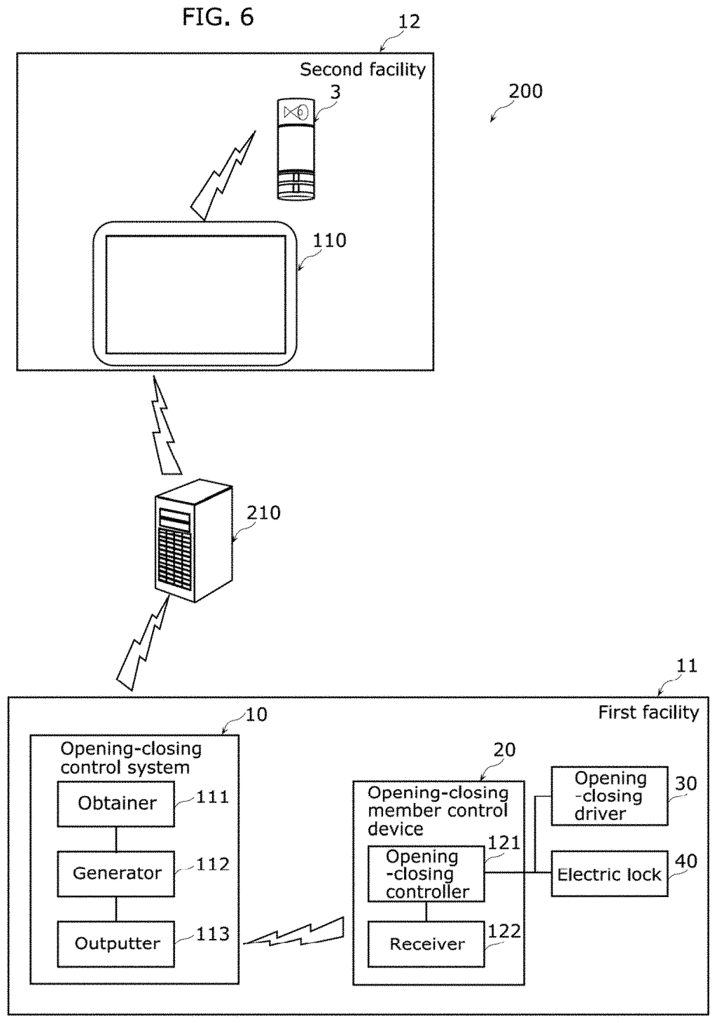

In addition, the opening-closing control system according to the above embodiment obtains alert information from the second facility, but the present invention is not limited thereto. As shown in FIG. 6, opening-closing control system 10 may obtain the alert information via another facility where no fire has occurred, or obtain the alert information from information processing device 210 such as a server via the network. That is, notification system 200 including opening-closing control system 10 may further include terminal device 110 mounted on second facility 12 and information processing device 210. FIG. 6 is a block diagram showing opening-closing control system 10 further including terminal device 110 and information processing device 210 according to a variation. For this reason, alert system 3 may transmit alert information to information processing device 210. At this time, information processing device 210 may receive the alert information transmitted by terminal device 110 of second facility 12, specify one or more first facilities 11 in the vicinity of second facility 12 based on the received alert information, and transmit the alert information to opening-closing control system 10 of the specified one or more first facilities 11. In this way, opening-closing member control device 20 closes opening 22 by opening-closing member 23, and electric lock 40 unlocks the key. It should be noted that when information processing device 210 obtains the alert information, information processing device 210 may ask the user of first facility 11 equipped with opening-closing control system 10 whether openings 22 may be closed by opening-closing members 23. Alternatively, when information processing device 210 obtains the alert information, information processing device 210 may ask the user of second facility 12 whether openings 22 may be closed by opening-closing members 23 of first facility 11.

In addition, according to the above embodiment, the alert system may output alert information to the surroundings by the user operating an inputter such as a button. That is, the user can select whether the alert system outputs alert information to the surroundings by operating a button. It should be noted that the alert system may automatically output alert information.

In addition, according to the above embodiment, when the alert information transmitted by the alert system is a false alert, the user may output cancellation information indicating that the alert information transmitted by the alert system to the surroundings by the operation is a false alert. In this case, when the opening-closing control system obtains the cancellation information, the opening-closing control system may output a control signal for opening the opening-closing members to the opening-closing member control device to cause the opening-closing member control device to open the opening-closing members.

In addition, the program using the opening-closing control method according to the above embodiment may be stored in the storage device mounted on the computer.

In addition, each processor included in the opening-closing control system according to the above embodiment is typically realized as an LSI which is an integrated circuit. These may be individually integrated into one chip, or may be integrated into one chip so as to include a part or all of them.

In addition, the circuit integration is not limited to the LSI, and may be realized by a dedicated circuit or a general-purpose processor. A field programmable gate array (FPGA) that can be programmed after the LSI is manufactured, or a reconfigurable processor that can reconfigure the connection and settings of the circuit cells inside the LSI may be used.

It should be noted that in each of the above embodiments, each component may be configured by dedicated hardware or may be realized by executing a software program suitable for each component. Each component may be realized by a program executer such as a CPU or a processor reading out and executing a software program recorded on a recording medium such as a hard disk or a semiconductor memory.

In addition, the numbers used above are all for the exemplary purpose for describing the present disclosure, and the embodiments of the present disclosure are not limited to the exemplified numbers.

In addition, the division of the functional block in the block diagram is an example, and a plurality of functional blocks may be realized as one functional block, one functional block may be divided into a plurality of functional blocks, and some functions may be transferred to other functional blocks. In addition, the functions of a plurality of functional blocks having similar functions may be processed by a single hardware or software in parallel or in a time division manner.

In addition, the order in which each step in the flowchart is executed is for the exemplary purpose for describing the present disclosure in detail, and may be an order other than the above. In addition, a part of the above steps may be executed at the same time as (parallel to) other steps.

In addition, a form obtained by applying various variations that a person skilled in the art can conceive to the embodiment, or a form realized by arbitrarily combining the components and functions in the embodiment within the scope without departing from the spirit of the present disclosure is also included in this disclosure.

### REFERENCE SIGNS LIST

3 Alert system
10 Opening-closing control system
11 First facility (facility)
12 Second facility (different facility)
22 Opening
23, 23a, 23b, 23c Opening-closing member (23a Window shutter, 23b Entrance door, 23c Shutter)
40 Electric lock
111 Obtainer
113 Outputter

1. An opening-closing control system, comprising:
an outputter that outputs a signal for controlling an operation of an opening-closing member configured to open and close an opening provided in a first facility; and
an obtainer that obtains information on an alert from a second facility different from the first facility,
wherein the outputter outputs the signal for controlling the opening or closing of the opening by the opening-closing member based on the information.

2. The opening-closing control system according to claim 1,
wherein the information on the alert is issued as a signal from an alert system provided in the second facility.

3. The opening-closing control system according to claim 2,
wherein the signal from the alert system is a signal from an alert system associated with the opening-closing control system among alert systems provided in the second facility.

4. The opening-closing control system according to claim 1,
wherein the information on the alert is emitted as a sound from an alert system provided in the second facility.

5. The opening-closing control system according to claim 1,
wherein the opening-closing member includes a shutter, and
the outputter outputs a signal for closing the shutter based on the information.

6. The opening-closing control system according to claim 1,
wherein the opening-closing member includes a door, and
the outputter outputs a signal for unlocking an electric lock of the door based on the information.

7. An opening-closing control method, comprising:
outputting a signal for controlling an operation of an opening-closing member configured to open and close an opening provided in a first facility;
obtaining information on an alert from a second facility different from the first facility; and
outputting the signal for controlling the opening or closing of the opening by the opening-closing member based on the information obtained.

8. A non-transitory computer-readable storage medium having stored thereon a program for causing a computer to execute the opening-closing control method according to claim 7.
